(19) United States
(12) Patent Application Publication
(10) Pub. No.: US 2008/0072719 A1
(43) Pub. Date: Mar. 27, 2008

(54) NON-FERROUS BIT FOR USE WITH A MAGNETIC CHUCK

(76) Inventor: Burton Kozak, Chicago, IL (US)

Correspondence Address: CHERSKOV & FLAYNIK, THE CIVIC OPERA BUILDING, 20 NORTH WACKER DRIVE, SUITE 1447, CHICAGO, IL, 60606, US

(21) Appl. No.: 11/862,011

(22) Filed: Sep. 26, 2007

Related U.S. Application Data
(63) Continuation-in-part of application No. 11/528,725, filed on Sep. 27, 2006.

(51) Int. Cl. B25B 23/00; B21K 5/00

(52) U.S. Cl. 81/438; 76/119

(57) ABSTRACT

A device that allows the use of tool- and drill-bits in conjunction with a magnetic chuck comprises ferromagnetic material or a permanent magnet that is attached to the bit.

This is a Continuation-In-Part application of application Ser. No. 11/528,725 filed on Sep. 27, 2006 now pending.

### BACKGROUND OF THE INVENTION

1. Field of the Invention

This invention relates to the field of tool- and drill-bits and, more particularly, this invention relates to bits adapted for use with a magnetic chuck.

2. Background of the Invention

Iron bits can be used with a magnetic chuck. But such bits are ill-suited when certain properties concerning hardness, resistance to corrosion, or tolerance to high temperatures are required. For these situations carbide, zinc, and stainless steel are much preferable. Yet presently, such bits cannot take advantage of devices which have magnetic chucks. Magnetic chucks present many advantages, especially quick bit engagement and release.

Magnetic means for securing driver-bits are described in several U.S. patents. For instance, U.S. Pat. No. 2,471,764 to Miller et al. (Jan. 31, 1946) discloses a driver tool wherein driver bits and other objects are magnetically confined in tubes that are attached to a handle.

U.S. Pat. No. 4,448,097 to Rocca (May 15,1984) discloses a driver tool with a similar construction.

U.S. Pat. No. 6,666,115 to Liu (Dec. 23, 2003) discloses a driver tool with a magnetic chuck.

U.S. Pat. No. 7,000,509 to Shiao (Feb. 21, 2006) discloses a driver tool wherein a plurality of driver bits are magnetically confined in a cassette comprising a plurality of angularly disposed storage chambers. In all of these inventions, the bits magnetically confined are limited to ferrous bits.

A need exists in the art for non-ferrous bits that can be utilized in conjunction with a magnetic chuck and for a method that would modify non-ferrous bits so that they can be utilized in conjunction with magnetic chucks. The method should enable the magnetic utilization of items containing non-ferrous materials and the utilization of popular non-ferrous materials, such as zinc and carbides, for use as magnetic drill bits, screw-driver tips, sockets, and other fastener engagement tools.

### SUMMARY OF THE INVENTION

An object of this invention is to provide a magnetizable component for a non-ferrous bit and a method for magnetizing a component of a non-ferrous bit that overcome many of the disadvantages of the prior art.

Another object of the present invention is to provide a non-ferrous bit that responds to a magnetic force. A feature of this invention is a component attached to the bit that is magnetizable. An advantage of this invention is that it allows an operator to use a magnetic chuck with such a bit.

Yet another object of this invention is to provide a method for the manufacture of non-ferrous bits which ultimately can be used with a magnetic chuck. A feature of this invention is that the method can be applied to a wide variety of non-ferrous bits. An advantage of this invention is that it allows the use of non-ferrous bits that have especially desirable properties in conjunction with a magnetic chuck.

In brief, this invention provides attachments to non-ferrous bits so that they can be utilized in conjunction with a magnetic chuck.

Also provided is a method for modifying non-ferrous bits so that they can be utilized in conjunction with magnetic chucks. The materials utilized would be strongly attracted in a magnetic field, i.e materials with a strong magnetization, either inherent (permanent magnets) or induced (ferromagnetic materials).

### BRIEF DESCRIPTION OF THE DRAWING

The foregoing and other objects, aspects and advantages of this invention will be better understood from the following detailed description of the preferred embodiments of the invention with reference to the drawing, in which:

FIG. 1 is an overall schematic profile view of an exemplary embodiment of a non-ferrous bit that can be utilized in conjunction with a magnetic chuck, in accordance with features of this invention;

FIG. 2a is a schematic view of an alternative exemplary embodiment of a non-ferrous bit that can be utilized in conjunction with a magnetic chuck, in accordance with features of this invention;

FIG. 2b is a schematic view of an alternative exemplary embodiment of a non-ferrous bit that can be utilized in conjunction with a magnetic chuck, in accordance with features of this invention;

FIG. 2c is a schematic view of an alternative exemplary embodiment of a non-ferrous bit that can be utilized in conjunction with a magnetic chuck, in accordance with features of this invention;

FIG. 3a is a schematic profile view of another alternative exemplary embodiment of a non-ferrous bit that can be utilized in conjunction with a magnetic chuck, in accordance with features of this invention;

FIG. 3b is a schematic view of a plurality of non-ferrous bits that can be utilized in conjunction with a magnetic chuck, in accordance with features of this invention;

FIG. 4a is a schematic profile view of an exemplary embodiment of an attachment for a non-ferrous bit that can be utilized in conjunction with a magnetic chuck, in accordance with features of this invention;

FIG. 4b is a schematic profile view of another exemplary embodiment of an attachment for a non-ferrous bit that can be utilized in conjunction with a magnetic chuck, in accordance with features of this invention;

FIG. 5A is a schematic profile view of yet another exemplary embodiment of an attachment for a non-ferrous bit that can be utilized in conjunction with a magentic chuck, in accordance with features of this invention; and

FIG. 5B is a schematic profile view of another exemplary embodiment of an attachment for a non-ferrous bit that can be utilized in conjunction with a magentic chuck, in accordance with features of this invention.

### DETAILED DESCRIPTION OF THE INVENTION

This invention provides a device attached to a non-ferrous bit allowing that bit to be used in conjunction with a magnetic chuck. Also, this invention provides a method for adapting non-ferrous bits for use with a magnetic chuck. The invented device comprises material that is attracted by a magnetic field, i.e. material with a strong magnetization. Thus, the material is either a permanent magnet or ferrous material in which magnetization is induced when it is placed in close spatial relationship to a magnetic field so as to contact the lines of flux of the field. Where the material is a permanent magnet, the lines of magnetic flux extend substantially along a longitudinal axis of the bit

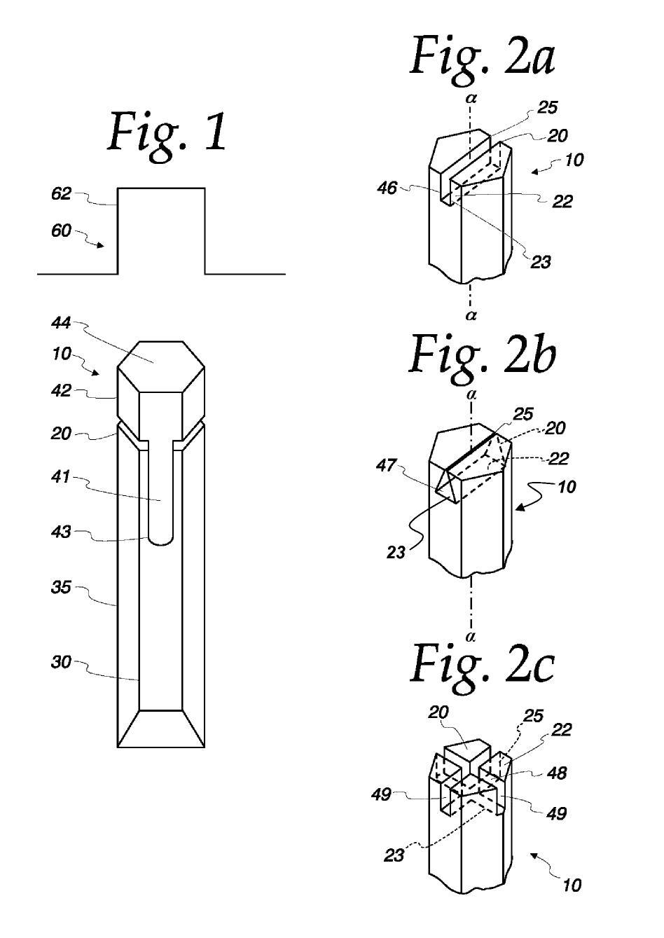

FIG. 1 is an overall schematic profile view of an exemplary embodiment of the invention. In this embodiment, the invented device resembles a nail. As depicted in FIG. 1, the invented device 10 is attached at a first end or heel 20 of a bit 30. The invented device 10 comprises an elongated shank 41 terminating at a first end as a radially extending head 42. The shank and head may comprise ferrous material, (i.e. material that acquires a magnetization when exposed to a magnetic field), or may constitute a permanent magnet. In either case, a second end or tip 43 of the shank constitutes a magnetic pole (say a South magnetic pole) while an outwardly and axially facing surface 44 of the head 42 constitutes a magnetic pole of the opposite polarity. The device 10 is adapted to come into direct contact with the magnet(s) in a magnetic chuck when a device-bearing bit is inserted in such a chuck.

The device 10 can be inserted in a drill bit, a tool bit or some other fastener engaging device. Typically, the bit 30 comprises a cylindrically shaped body 35 (such as a shaft) or some other bulk configuration adapted to receive the device. A proximal end 20 of the bit defines a heel defining either a circular or a non-circular (e. g. polygonal) cross-section. In FIG. 1, the device 10 is shown positioned coaxially within the body 35 of the bit 30 such that a periphery of the radially-extending head section 42 is substantially flush with longitudinally extending regions of the body 35 of the bit head. Where the bit 30 is massive enough, one may dispense with the head 42, and have an insert comprising only a shank 41. This embodiment can be manufactured at a comparatively low cost, with an axial cavity being first bored in the bit and then filled with a molten ferrous material.

The proximal end 20 of the bit is received in a magnetic chuck 60 which forms a socket 62. This chuck may comprise a permanent magnet or a magnetizable material wherein magnetization is induced by an electric current, or by a current carrying coil. The chuck may also comprise a ball detente mechanism, in which case the body 35 of the bit comprises a groove (not shown) adapted to be engaged by the ball detente mechanism. Where the body 35 has a circular cross-section, the body surface may be knurled or may comprise wings projecting radially therefrom.

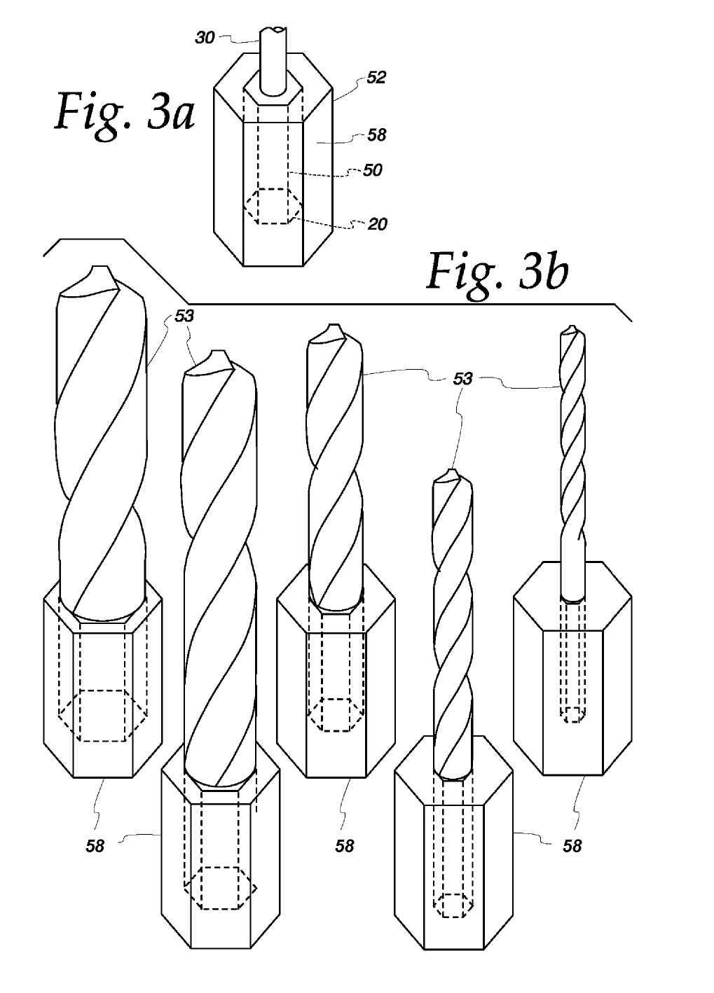

FIG. 2a illustrates another embodiment wherein the invented device 10 comprises a rectangular slab 46. Optionally the device may comprise a head (not shown) analogous to the head 42 on the device shown in FIG. 1. The slab 46 slidably communicates with a region of the bit defining a complimentary-shaped channel 22. In this embodiment, the channel defines surfaces which extend both axially and radially relative to the longitudinal axis α of the body. A distal end 23 of the channel is closed while a proximal end 25 is open and forms an aperture with the proximal end 20 of the bit. This embodiment can also be manufactured at a very low cost as the device can be press fit into the channel. This embodiment can be modified using inserts of a variety of shapes.

FIG. 2b illustrates one such variation wherein the invented device 10 comprises a wedge-shaped insert 47. Again, optionally the device may comprise a head (not shown) analogous to the head 42 on the device shown in FIG. 1. The wedge 47 slidably communicates with a region of the bit forming a radially extending channel 22 whereby the channel is open at either or both its ends so as to define apertures in the exterior surfaces of the body. This will enable the device to slidably communicate with the body in a direction generally perpendicular to the longitudinal axis α. A distal end 23 of the channel is closed while a proximal end 25 is open and forms an aperture with the proximal end 20 of the bit. This wedge-shaped embodiment has the advantage that there is little likelihood that the insert would be extruded by an axially-directed magnetic force.

Alternatively, the channel 22 can extend axially, so that the body 35 slidably receives the device 10 in a direction parallel to the longitudinal axis α.

FIG. 2c illustrates yet another variation wherein the invented device 10 comprises an x-shaped insert 48. Again, optionally the device may comprise a head (not shown) analogous to the head 42 on the device shown in FIG. 1. The x-shape insert comprises two intersecting slabs 49. The device slidably communicates with a region of the bit forming an x-shaped axially extruding channel 22. A distal end 23 of the channel is closed while a proximal end 25 is open and forms an aperture with the proximal end 20 of the bit. This x-shaped embodiment offers a relatively large mass of magnetic material with little effect on the structural integrity of the bit.

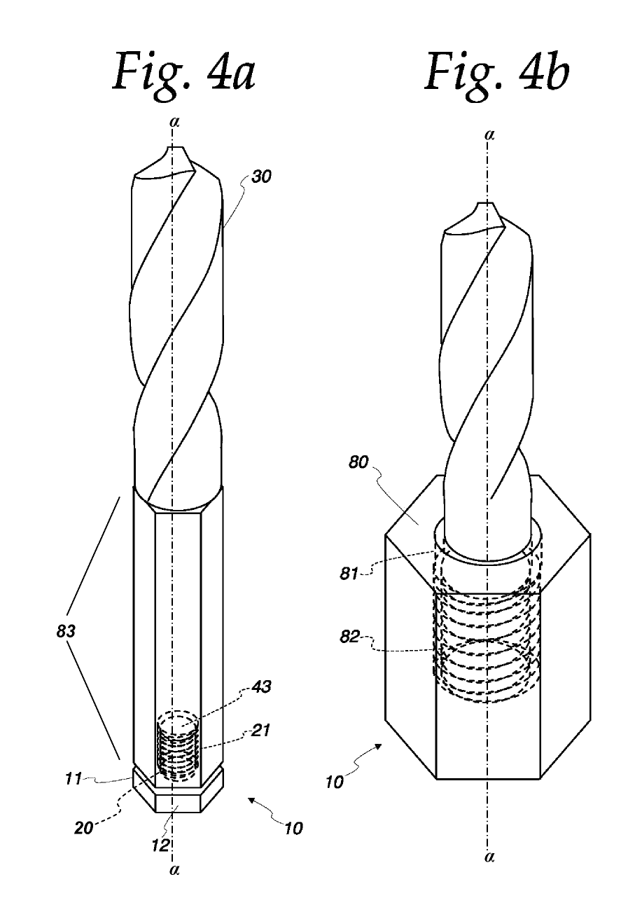

FIG. 3a illustrates yet another embodiment wherein the invented device comprises a sleeve 58 adapted to slidably receive the bit 30. The heel 20 of the bit 30 has been inserted such that the longitudinal axis of the bit is coaxially arranged with the sleeve 58. The sleeve 58 defines an inner surface 50 that matches the cross-section of the bit 30 and an outer surface 52 that matches the cross-section of a socket 62 and/or of the magnetic chuck 60 as depicted in FIG. 1. As long as the cross-sections are non-circular, this allows for torque to be applied from the chuck or socket, which is engaging the outer surface 52 of the sleeve, to the bit 30. In the alternative, as depicted in FIG. 4b, the heel may comprise a section with a male thread adapted to be received in a cavity with a matching female thread.

The embodiment depicted in FIG. 3a has the advantage that one can have a plurality of bits 30, each with a different cross-section, that are all inserted in sleeves with complimentary cross-sections. An outer surface 52 of the sleeve defines a typical topography (e.g. a standard size ¼ inch hex). Depicted in FIG. 3b, is a set of different-size drill bits that form a set 53 featuring a standard size sleeve 58 that can all be received in the same socket 62 of a magnetic chuck 60 as depicted in FIG. 1. This allows for very fast bit interchange and optimization of use of impact drivers many of which feature a certain size chuck aperture. Similarly one can have a set of different headed (Phillips, Allen, etc. . . . ) tool-bits

Fabrication Details.

A variety of means may be employed to attach the invented device 10 to a bit or to a shaft. For all three of the embodiments described in FIGS. 1, 2, and 3, the attachment may be effected by integrally molding the device to the end of the bit.

Alternatively, for these and other embodiments, a reversible attachment may be effected, and by a variety of means. For instance, FIG. 4a depicts an arrangement where the inserted device 10 constitutes a screw 11, with a head 12 (or without) and a threaded shank 43. The screw contains iron or is otherwise ferrous containing, so as to be generally able to impart magnetic qualities to the bit. The threaded shank 43 is received in either an axially-extending or radially-extending (latter not shown) threaded bore 21 in a bit 30. FIG. 4a depicts the screw inserted into the heel or proximal end 20 of the bit 30. However, the screw, or plurality of screws can be inserted in the bit, for example, with one screw inserted in the heel 20 of the bit and another ferrous-containing screw mating with the bit at a configuration generally perpendicular to the longitudinal axis of the bit. In one embodiment, ferrous-based screws are flush mounted to a longitudinal extending surface 83 of the bit, so as to extend perpendicularly from the longitudinal axis α of the bit. In this embodiment, the screws are arranged in relationship to each other so as to be placed about the circumference of the bit in either an asymmetrical configuration (which is the case if just one screw is utilized) or symmetrical configuration.

Similarly, in the sleeve embodiment depicted in FIG. 3a and where the bit 30 is a right-handed drill bit, a possible arrangement is depicted in FIG. 4b where the drill bit heel 80 has a right-hand threaded portion 81 and the sleeve a matching threaded bore 82. Alternatively a reversible attachment may be effected by means of a ball-detente mechanism or set screw.

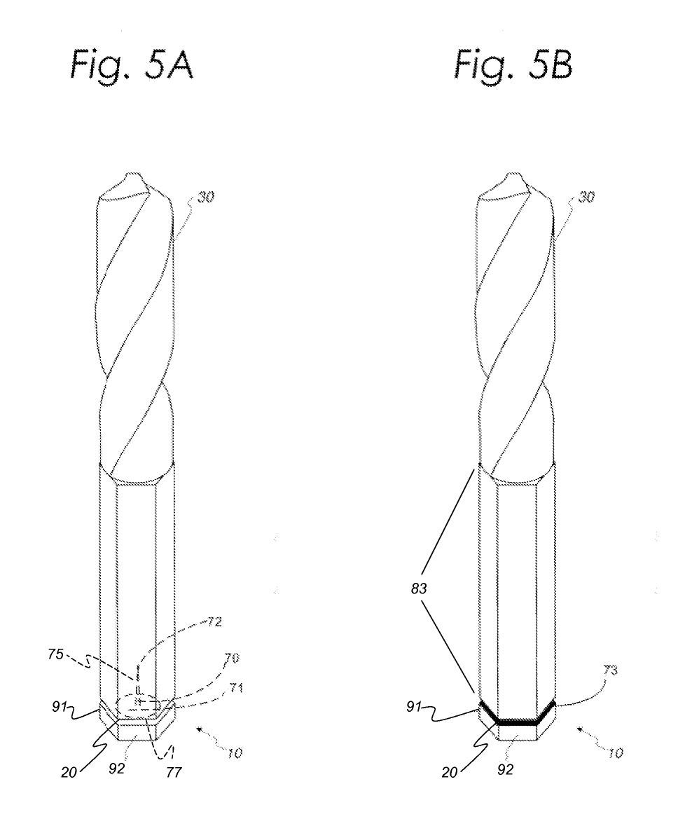

Additional means of attachment of ferrous substrates to a nonferrous bit are depicted in FIGS. 5A and 5B. FIG. 5A depicts a ferrous-based tack 70 received by the proximal end 20 or heel of the bit. The tack 70 comprises a base 71 (or head) defining a proximal end of the tack such that a first surface 77 of the base is that normally pressed upon by a user of the tack. That first surface faces outwardly when the tack penetrates a surface. As with typical tacks, a shaft 75 is integrally molded with the base 71 or head of the tack to extend in a direction opposite the direction faced by the first surface 77 of the base 71 of the tack. The shaft 75 terminates at a point 72.

In one embodiment of the invention, the tack confers ferrous characteristics to a non-ferrous bit when the tack is frictionally, removably received by the heel 20 of the bit. To accommodate frictional retention of the tack to the bit, the bit defines an axially extending channel or tunnel, slightly smaller in inner diameter than the outer diameter of the shaft 75 of the tack. Alternatively, or in addition to frictional engagement, the tack is held in place with adhesive whereby fastens the shaft 75 of the tack to inside walls of the bit defining the axially extending chamber accepting the shaft. The heretofore described tack-bit configuration combines ferrous material with a nonferrous bit to confer magnetization characteristics to the bit.

In instances where the bulk of the bit is such that the ferrous material contained in a typical thumb tack will not confer magnetization characteristics to the bulk of the bit, the bit is first mated with a ferrous substrate 91 (as seen in FIG. 5A). Optionally, the periphery 92 of the substrate 91 defines a cross section identical to the proximal end of the bit. As shown the periphery 92 of the substrate is hexagonal in cross section. In an embodiment of the invention, the ferrous substrate 91 is either integrally molded with a ferrous tack, glued or otherwise adhered to the tack. The tack 70 may optionally be positioned between the heel 20 of the bit and the screw 11 (as depicted in FIGS. 4a and 4b), thereby secures the screw 11 in the work piece 30.

Instead of using a tack, an embodiment of the invention disclosed by FIG. 5B utilizes adhesive 73 to secure the ferrous substrate 91 directly to the heel 20 of the bit 30 without the need for a tack positioned intermediate the heel and the ferrous substrate 91. While the ferrous substrate is depicted as a bulk structure, the invention also enables the use of ferrous-based filings, powders, and pastes for use in combination with nonferrous bits to confer ferrous characteristics to the bit. For example, an adhesive containing such powders or filings is utilized whereby the proximal surfaces of the bit, along longitudinal extending surfaces 83, are coated with the adhesive. Not only does this confer ferrous characteristics to the bit, but upon drying, the bit-adhesive-ferrous filing combination confers added traction so as to enhance gripping of the bit by a chuck.

Permanent magnets fabricated using a variety of metals, e.g. Neodymium or Iron, and compounds, e.g. Alnico, Mumetal (an alloy of ca. 25% iron, 75% nickel, and small proportions of other elements) and compounds of rare earth elements, including Samarium-Cobalt and Neodymium-Iron-Boron (NIB) are available commercially in sizes and configurations suitable for all of the embodiments described supra.

Ferromagnetic materials include Nickel, Cobalt, iron, and a variety of compounds and alloys.

Finally, the invented magnetic insert adapted to be received in a shaft can be used in conjunction not only with metallic shafts but also with shafts fabricated from a broad variety of materials including, but not limited to, plastics, nylon, fiberglass, ceramics, etc. . . . Also, the invented insert may be used in conjunction with a myriad other implements in addition to shafts.

While the invention has been described in the foregoing with reference to details of the illustrated embodiments, these details are not intended to limit the scope of the invention as defined in the appended claims.

The embodiment of the invention in which an exclusive property or privilege is claimed is defined as follows:

1. A non-ferrous bit for use in connection with a magnetic chuck comprising material that is attracted by a magnetic field attached to the bit.

2. The bit as recited in claim 1 wherein said material comprises a permanent magnet.

3. The bit as recited in claim 1 wherein said material comprises ferrous material.

4. The bit as recited in claim 1 wherein said material is substantially encapsulated by the bit.

5. The bit as recited in claim 1 wherein said material is reversibly attached to the bit.

6. The bit as recited in claim 1 wherein said material comprises one or more slabs inserted in an end of the bit.

7. The bit as recited in claim 2 wherein said material comprises a cylinder inserted in an end of the bit such that lines of magnetic flux extend substantially along a longitudinal axis of the bit.

8. The bit as recited in claim 1 wherein said material defines a sleeve adapted to slidably receive an end of the bit.

9. The bit as recited in claim 8 wherein said sleeve defines an inner surface with a non-circular cross-section identical to a cross-section of the bit.

10. The bit as recited in claim 1 wherein said material is selected from the group consisting of Iron, Nickel, Cobalt, Neodymium, Praseodymium, and their alloys.

11. The bit as recited in claim 1 wherein said material is ferromagnetic.

12. The bit as recited in claim 1 wherein said material is integrally molded with the bit.

13. A method for enabling a non-ferrous bit to be used with a magnetic chuck, said method comprising attaching material to the bit that is attracted by a magnetic field.

14. The method as recited in claim 13 wherein said material comprises a permanent magnet.

15. The method as recited in claim 13 wherein said material comprises ferrous material.

16. The method as recited in claim 13 wherein the material is substantially encapsulated by the bit.

17. A device for converting a non-ferrous implement into an implement with a magnetic response, said device comprising material that is attracted by a magnetic field and that is attached to the implement.

18. The device as recited in claim 17 wherein said material is substantially encapsulated by the implement.

19. The device as recited in claim 17 wherein said material is reversibly attached to the implement.

20. The device as recited in claim 17 wherein said material is integrally molded with the implement so as to be substantially encapsulated by the implement.

21. The device as recited in claim 19 wherein said material is attached to the implement by the use of a tack embedded in the implement.

22. The device as recited in claim 17 wherein said material is attached to the implement by a layer of adhesive which bonds the material and the implement.
